(19) United States
(12) Patent Application Publication
(10) Pub. No.: US 2021/0162489 A1
(43) Pub. Date: Jun. 3, 2021

(54) WASH COMPOSITION FOR REDUCING FORMALDEHYDE EMISSIONS

(71) Applicant: HÜTTENES-ALBERTUS Chemische Werke Gesellschaft mit beschränkter Haftung, Düsseldorf (DE)

(72) Inventors: Gérard LADÉGOURDIE, Düsseldorf (DE); Bernd DONNER, Köln (DE); Klaus SEEGER, Hannover (DE)

(73) Assignee: HÜTTENES-ALBERTUS Chemische Werke Gesellschaft mit beschränkter Haftung, Düsseldorf (DE)

(21) Appl. No.: 17/263,477

(22) PCT Filed: Jul. 26, 2019
(86) PCT No.: PCT/EP2019/070249

§ 371 Date: Jan. 26, 2021

(30) Foreign Application Priority Data
Jul. 27, 2018 (DE) 10 2018 118 291.0

(51) Int. Cl. B22C 3/00; C09D 7/63; C09D 175/04; C09D 7/61; C09D 7/48; B22C 1/22; C09D 161/02

(52) U.S. Cl. CPC B22C 3/00; C09D 7/63; C09D 175/04; C09D 7/61; C09D 161/02; B22C 1/2273; B22C 1/2246; B22C 1/224; C09D 7/48

(57) ABSTRACT

What is described is the use of a composition containing one or more formaldehyde scavengers for production of a coating on a main body of a mold or core for metal casting that emits formaldehyde when heated, wherein the coating forms a surface of the mold or core that comes into contact with a metal melt in the casting operation.

What is described is the use of particular compounds as formaldehyde scavengers in a coating on a main body of a mold or core for metal casting that emits formaldehyde when heated, wherein the coating forms a surface of the mold or core that comes into contact with a metal melt in the casting operation, and the use of a composition containing one or more of these compounds for production of a coating on a main body of a mold or core for metal casting that emits formaldehyde when heated, wherein the coating forms a surface of the mold or core that comes into contact with a metal melt in the casting operation. Also described are corresponding molds and cores and the production thereof.

Molds and cores for metal casting are produced by shaping a molding material mixture comprising a mold base material (e.g. sand) and a binder, and then curing the shaped molding material mixture. This frequently involves using organic binders that emit formaldehyde when heated, for example polyurethanes formed by polyaddition of a phenol-formaldehyde resin with a polyisocyanate, or formaldehyde condensation resins, e.g. formaldehyde condensation resins from the group consisting of phenol-formaldehyde resins, furan-formaldehyde resins, urea-formaldehyde resins, melamine-formaldehyde resins.

Molds are negatives; they contain the cavity to be cast, which results in the casting to be manufactured. The inner contours of a casting may be formed by cores. In the production of the mold, by means of a model of the casting to be manufactured, it is possible to shape the cavity into the molding material. Cores are usually shaped in a core box.

Typically, in the production of molds and cores for metal casting by shaping a molding material mixture (as described above) and then curing the shaped molding material mixture, a main body of the mold or core is first formed, which already has the contours of the required mold or the required core. Especially in the case of steel and iron casting, a coating is typically produced on the main body thus formed, the coating forming a surface of the mold or core that comes into contact with a metal melt in the casting operation. Such coatings are typically referred to as refractory coatings. In the context of the present application, the term “mold” or “core” refers in each case to the entirety of the main body of the mold or core and the coating disposed on this main body (refractory coating). This coating acts as an interface and/or barrier layer between the main body of the core or mold and the cast metal, and serves, inter alia, for controlled suppression of mechanisms of casting defect formation at the interface between metal and core/mold or for utilization of metallurgical effects. In general, refractory coatings in foundry technology should fulfill the following functions in particular, which are known to the person skilled in the art:
improving the smoothness of the casting surface and/or
preventing chemical reactions between constituents of the molding material mixture and the metal melt, hence facilitating separation between mold/core and casting and/or
preventing surface defects on the casting, for example gas bubbles, penetrations, leaf veins and/or scabs.

Ready-to-use compositions for coating of the main bodies of molds and cores are typically suspensions of fine-grain, refractory to highly refractory inorganic materials (refractories) in a carrier liquid (e.g. water, alkanols, or mixtures thereof), where further constituents may be suspended or dissolved in the carrier liquid. The refractory coating composition is applied to the main body in a suitable manner, and then the carrier liquid is removed by drying, forming a coating on the main body. The drying is typically effected at a temperature above 40° C., preferably in the range from 50° C. to 200° C. At these temperatures, the main bodies of the molds or cores emit significant amounts of formaldehyde. Such emissions constitute considerable pollution of the workplace.

DE 10 2008 025 311 A1 discloses a casting mold for metal casting, wherein a layer of a material that absorbs pollutants is disposed in at least sections of gas exit areas of the casting mold. Gas exit areas are understood to mean the areas of the casting mold through which gaseous components can escape from the casting mold during the casting operation. The gas exit area may correspond to the entire outer surface of the casting mold. Alternatively, it is possible that just a portion of the outer surface of the casting mold is utilized for the release of gaseous components. For instance, in the case of in-box metal casting, a box is utilized for construction of the casting mold, which covers the underside and the lateral faces of the casting mold. In that case, essentially only the top face of the casting mold is available for a release of gaseous components. An outer surface of the casting mold is understood to mean the surfaces through which offgases formed in the casting operation can leave the casting mold. This outer surface is visible when the casting mold is viewed from the outside, and does not come into contact with the liquid metal in the casting operation. By contrast, an inner surface is understood to mean, for example, the surface of the mold cavity surrounded by the casting mold.

Materials that bind formaldehyde by chemical reactions to give nonvolatile reaction products are not disclosed in DE 10 2008 025 311 A1.

EP 0 012 169 A1 discloses a particleboard or fiberboard bound predominantly with amino resins, characterized in that part of the area of the board, preferably the middle layer, at least partly contains a binder that is not part of the group of the amino resins and simultaneously tolerates the introduction of formaldehyde-reactive substances in particular amounts that react with formaldehyde under the action of moisture and/or heat or release substances that can in turn bind formaldehyde.

It is an object of the present invention to reduce the emissions of formaldehyde that arise in the drying of the refractory coating of molds or cores that release formaldehyde when heated.

In a first aspect of the invention, this object is achieved by the use of a composition comprising
(a) particles of one or more refractories
(b) one or more compounds selected from the group consisting of
   β-dicarbonyl compounds
   di- and trihydric phenols
   phenol-formaldehyde novolaks and resorcinol-formaldehyde novolaks
   amino acids
   primary and secondary aminosilanes
   melamine, benzoguanamine, urea and derivatives thereof
   hydrazine and carbonohydrazide and derivatives thereof
   primary and secondary amines
   tree resins, tannins and lignins

where the total mass of compounds (b) is 0.1% by weight to 10% by weight, preferably 0.1% by weight to 5% by weight, based on the total mass of the particles (a) of the refractories,
(c) optionally a carrier liquid selected from the group consisting of water, alkanols and mixtures thereof,

for production of a coating on a main body of a mold or core for metal casting that emits formaldehyde when heated, wherein the coating forms a surface of the mold or core that comes into contact with a metal melt in the casting operation. Preferably, the coating does not just form the surface of the mold or core that comes into contact with a metal melt in the casting operation, but additionally extends over further regions of the mold or core. The coating preferably extends over 50% or more, further preferably over 70% or more, more preferably over 80% or more, especially preferably over 90% or more, in particular over 95% or more, of the surface of the mold or core. Most preferably, the coating extends over the entire surface of the mold or core.

The main body of the mold or core here is typically formed from a molding material mixture that has been bound with a binder that emits formaldehyde when heated, wherein the binder is preferably selected from the group consisting of:
polyurethanes formed by polyaddition of a phenol-formaldehyde resin with a polyisocyanate
formaldehyde condensation resins, preferably selected from the group consisting of phenol-formaldehyde resins, furan-formaldehyde resins, urea-formaldehyde resins, melamine-formaldehyde resins.

More preferably, the main body of the mold or core has been formed from a molding material mixture that has been bound with a binder that emits formaldehyde when heated, wherein the binder is selected from the group consisting of:
polyurethanes formed by polyaddition of a phenol-formaldehyde resin with polyisocyanate
phenol-formaldehyde resins and
furan-formaldehyde resins.

The binder is present in cured form in the main body of the mold or core.

It has been found that, surprisingly, in the case of molds and cores that emit formaldehyde when heated, the amount of formaldehyde released to the environment in the course of drying of the refractory coating is distinctly reduced when the refractory coating is produced using the above-defined composition. It is currently assumed that the compounds (b) are capable of binding formaldehyde by chemical reactions that form nonvolatile reaction products, such that less formaldehyde escapes from the core or mold into the environment. Therefore, the compounds (b) are referred to here as formaldehyde scavengers.

As well as the ability to irreversibly bind a nonvolatile reaction product with formaldehyde, a number of further criteria should be noted in the selection of the compounds (b). For instance, the compound (b) itself must not be volatile, and it must not break down at the temperatures at which the cores and molds are dried. The breakdown temperature must therefore be higher than the temperature at which the molds and cores are dried (50° C. to 200° C., preferably 100° C. to 180° C.). Preference is therefore given to those compounds (b) that are solids or high-boiling liquids having low vapor pressure. In addition, compound (b) must be soluble in a sufficient amount in the carrier liquid (c).

Furthermore, the compound (b) should as far as possible not be toxic, not require any particular occupational protection and safety precautions, and be reliably available on the market under acceptable conditions.

The compounds (b) are preferably selected from the group consisting of dialkyl esters of malonic acid (especially diethyl malonate), resorcinol, pyrogallol, phloroglucinol, glycine, melamine, urea, carbonohydrazide, tannins that are soluble in the carrier liquid (c) and lignins that are soluble in the carrier liquid (c). Particular preference is given to lignins, melamine, glycine and resorcinol.

Phenol-formaldehyde novolaks and resorcinol-formaldehyde novolaks are likewise formaldehyde scavengers, but the use thereof is generally not preferred. Phenol-formaldehyde novolaks or resorcinol-formaldehyde novolaks are preferably not used in the form of aerogels.

In the composition for use in accordance with the invention, the total mass of compounds (b) is 0.1% by weight to 10% by weight, preferably 0.1% by weight to 9% by weight, further preferably 0.1% by weight to 8% by weight, further preferably 0.1% by weight to 7% by weight, further preferably 0.1% by weight to 6% by weight, especially preferably 0.1% by weight 5% by weight, based on the total mass of the particles (a) of the refractories. In the case of a smaller amount of compounds (b), no significant decrease in formaldehyde emissions would be achieved. A higher amount of compounds (b) could affect the quality of the coating produced.

In accordance with the typical understanding of the person skilled in the art (cf. DIN 51060:2000-06), “refractory” refers to masses, materials and minerals that can at least briefly withstand the thermal stress on casting or solidification of an iron melt, usually cast iron. “Highly refractory” refers to masses, materials and minerals that can briefly withstand the heat of casting of a steel melt. The temperatures that can occur in the casting of steel melts are usually higher than the temperatures that can occur in the casting of iron or cast iron melts. Refractory masses, materials and minerals (refractories) and highly refractory masses, materials and minerals are known to the person skilled in the art, for example from DIN 51060:2000-06. Unless stated otherwise, pulverulent refractories then have an average grain size (preferably measured by means of light scattering to ISO 13320:2009-10) in the range from 0.1 to 500 μm, preferably in the range from 1 to 200 μm. Suitable refractories are especially those materials that have melting points at least 200° C. above the temperature of the metal melt used in the respective case and/or do not enter into any reaction with the metal melt.

The term “refractory” (a) as used here also includes highly refractory substances.

The refractories (a) are selected from those refractories that are typically used in refractory coatings, for example refractories selected from the group consisting of quartz, alumina, zirconia, aluminum silicates, nonswellable layered silicates, zirconium silicates, olivine, talc, mica, graphite, coke, feldspar, diatomite, kaolins, calcined kaolins, metakaolinite, iron oxide and bauxite.

The refractories (a) preferably comprise one or more refractories selected from the group consisting of quartz, alumina, zirconia, aluminum silicates, nonswellable layered silicates, zirconium silicates, olivine, talc, mica, graphite, coke, feldspar, diatomite, kaolins, calcined kaolins, metakaolinite, iron oxide and bauxite.

The refractories (a) more preferably comprise
(i) one or more refractories selected from the group consisting of quartz, alumina, zirconia, aluminum silicates, nonswellable layered silicates, zirconium silicates, olivine, talc, mica, graphite, coke, feldspar, diatomite, kaolins, calcined kaolins, metakaolinite, iron oxide and bauxite

and
(ii) one or more refractories selected from the group of the swellable layered silicates and the zeolites.

Swellable layered silicates also act as a rheology additive (inorganic thickener). The swellable layered silicates are preferably selected from the group of the smectites, hectorites, saponites, nontronites, vermiculites and montmorillonites.

The zeolites may be natural or synthetic zeolites.

The mass ratio of the refractories (i) to the refractories (ii) is preferably in the range from 20:1 to 5:1, more preferably 15:1 to 7:1.

For example, the refractories (a) comprise
(i) one or more refractories selected from the group consisting of quartz, alumina, zirconia, aluminum silicates, nonswellable layered silicates, zirconium silicates, olivine, talc, mica, graphite, coke, feldspar, diatomite, kaolins, calcined kaolins, metakaolinite, iron oxide and bauxite

and
(ii) one or more refractories selected from the group of the swellable layered silicates.

For example, the refractories (a) comprise
(i) one or more refractories selected from the group consisting of quartz, alumina, zirconia, aluminum silicates, nonswellable layered silicates, zirconium silicates, olivine, talc, mica, graphite, coke, feldspar, diatomite, kaolins, calcined kaolins, metakaolinite, iron oxide and bauxite

and
(ii) one or more refractories selected from the group of the zeolites.

The refractories (a) more preferably comprise
(i) one or more refractories selected from the group consisting of quartz, alumina, zirconia, aluminum silicates, nonswellable layered silicates, zirconium silicates, olivine, talc, mica, graphite, coke, feldspar, diatomite, kaolins, calcined kaolins, metakaolinite, iron oxide and bauxite

and
(ii) one or more refractories selected from the group of the swellable layered silicates, and one or more refractories selected from the group of zeolites.

It has been found that, surprisingly, compositions wherein the refractories (a), as well as one or more refractories (i) as defined above, also include one or more refractories (ii) selected from the group of the swellable layered silicates and the zeolites, wherein the swellable layered silicates are preferably selected from the group of the smectites, hectorites, saponites, nontronites, vermiculites and montmorillonites, achieve a particularly significant reduction in formaldehyde emissions. This was not to be expected since all that had been described to date for some representatives of the abovementioned refractories (ii) was a function as rheology additive.

In particular cases, or under particular experimental conditions, it is even possible with a refractory coating composition containing a combination of the abovementioned refractories (i) and (ii) and no compound (b) as defined above to achieve a significant reduction in formaldehyde emissions; see the comparative examples in which a comparative refractory coating composition was used, which contains a combination of the abovementioned refractories (i) and (ii) and no compound (b) as defined above. The mass ratio of the refractories (i) to the refractories (ii) is preferably in the range from 20:1 to 5:1, more preferably 15:1 to 7:1.

What is thus described here is also the use of a composition comprising
(a) particles of one or more refractories, where the refractories (a) comprise:
   (i) one or more refractories selected from the group consisting of quartz, alumina, zirconia, aluminum silicates, nonswellable layered silicates, zirconium silicates, olivine, talc, mica, graphite, coke, feldspar, diatomite, kaolins, calcined kaolins, metakaolinite, iron oxide and bauxite

and
(ii) one or more refractories selected from the group of the swellable layered silicates and the zeolites
(c) optionally a carrier liquid selected from the group consisting of water, alkanols and mixtures thereof,

for production of a coating on a main body of a mold or core for metal casting that emits formaldehyde when heated, wherein the coating forms a surface of the mold or core that comes into contact with a metal melt in the casting operation.

The carrier liquid (c) serves merely as vehicle for application of the substances suspended and dissolved therein to the main body of the core or mold, and is removed in the course of drying. The carrier liquid is in liquid form under standard conditions (20° C. and 1013.25 hPa) and is evaporable under standard pressure (1013.25 hPa) at temperatures in the range from 50° C. to 200° C. The carrier liquid (c) is preferably selected from the group consisting of water, methanol, ethanol and isopropanol.

Compositions for production of refractory coatings frequently contain further constituents such as
(d) wetting agents,
(e) rheology additives,
(f) binders,
(g) suspension aids
(h) biocides.

Suitable wetting agents (d), rheology additives (e), binders (f), suspension aids (g) and biocides (h) and their function and effect are known to the person skilled in the art.

Wetting agents (d) used are preferably anionic, cationic and non-ionic surfactants. The wetting agents (d) are preferably selected from the group consisting of the group of surfactants, more preferably from alkyne diols and derivatives thereof.

Rheology additives used are, for example, organic thickeners. These are preferably selected from the group consisting of polysaccharides, proteins and cellulose ethers. It is also possible to use inorganic thickeners from the group comprising swellable clay minerals, e.g. band silicates such as palygorskites (attapulgites), and fumed silicas. The abovementioned swellable layered silicates and zeolites also act as inorganic thickeners. Such inorganic thickeners, however, are refractories and are therefore assigned to constituent (a) in respect of concentration figures.

Binders (f) used are binders that self-cure under air or dry on removal of the carrier liquid (c). Preferred binders (f) are selected from the group of the polyvinyl alcohols, polyacrylates, polyvinylacetates, co-polymers of the aforementioned polymers, natural resins, dextrins, starches and peptides.

The suspension aids (g) are preferably selected from the group consisting of salts of metals from the group consisting of alkali metals, alkaline earth metals, iron and aluminum that are soluble in the carrier liquid (c), and mixtures thereof.

Compositions for use in accordance with the invention, as described above, include ready-to-use refractory coating compositions and precursors for formation of ready-to-use refractory coating compositions. Ready-to-use refractory coating compositions have a sufficiently high content of carrier liquid that they can be applied directly to the main body to form a coating. In a ready-to-use refractory coating composition, the mass of carrier liquid (c) is preferably 60% by weight to 80% by weight, based on the total mass of the composition. Precursors for production of a ready-to-use refractory coating composition do not contain any carrier liquid (c) (solid mixture) or contain a distinctly smaller amount of carrier liquid (c) compared to the ready-to-use refractory coating composition (concentrate). In the concentrates, the total mass of the carrier liquid (c) is 40% by weight to 65% by weight, preferably 40% by weight to 59% by weight, based in each case on the total mass of the composition.

A ready-to-use refractory coating composition is obtainable by suspending the solid mixture in a carrier liquid (c) (with dissolution of constituents of the solid mixture that are soluble in the carrier liquid (c)) or diluting the concentrate with a carrier liquid (c). The concentrate is typically diluted using a carrier liquid (c) having the same composition as the carrier liquid (c) of the concentrate. A ready-to-use refractory coating composition is thus producible by a process comprising the steps of
producing or providing a solid mixture or concentrate as defined above
adding carrier liquid (c) selected from the group consisting of water, alkanols and mixtures thereof, wherein the amount of carrier liquid (c) added is such as to result in a composition in which the total amount of the carrier liquid (c) is 60% by weight to 80% by weight, based on the total mass of the resulting composition.

The above remarks relating to suitable and preferred constituents (a)-(h) are applicable both in respect of concentrates and in respect of ready-to-use refractory coating compositions. In respect of solid mixtures, the above remarks relating to suitable and preferred refractories (a) and the above remarks relating to suitable and preferred constituents (b) and (d)-(h) are applicable, to the extent that they are solids.

A second aspect of the present invention relates to a composition for production of a coating on a main body of a mold or core for metal casting that emits formaldehyde when heated, wherein the coating forms a surface of the mold or core that comes into contact with a metal melt in the casting operation. A composition of the invention comprises
(a) particles of one or more refractories
(b) one or more compounds selected from the group consisting of
   β-dicarbonyl compounds
   di- and trihydric phenols
   phenol-formaldehyde novolaks and resorcinol-formaldehyde novolaks
   amino acids
   primary and secondary aminosilanes
   melamine, benzoguanamine, urea and derivatives thereof
   hydrazine and carbonohydrazide and derivatives thereof
   primary and secondary amines
   tree resins, tannins and lignins
   wherein the total mass of compounds (b) is 0.1% by weight to 10% by weight, preferably 0.1% by weight to 9% by weight, further preferably 0.1% by weight to 8% by weight, further preferably 0.1% by weight to 7% by weight, further preferably 0.1% by weight to 6% by weight, especially preferably 0.1% by weight to 5% by weight, based on the total mass of the particles (a) of the refractories,
(c) a carrier liquid selected from the group consisting of water, alkanols and mixtures thereof, where the total mass of the carrier liquid (c) is 40% by weight to 80% by weight, based on the total mass of the composition.

With regard to the selection of the refractories (a), compounds (b), carrier liquids (c) and further constituents (d) and (h) as defined above, the same applies as set out above in respect of the first aspect of the invention. Preference is given to compositions wherein constituents (a)-(h) are selected from the constituents (a)-(h) identified as preferred in respect of the first aspect of the invention above.

Compositions of the invention include ready-to-use refractory coating compositions (as described above in the context of the first aspect of the invention) and concentrates (as described above in the context of the first aspect of the invention) for formation of ready-to-use refractory coating compositions.

A further aspect of the present invention relates to a mold or core for metal casting. A core or mold of the invention comprises:
a main body that emits formaldehyde when heated,
and a coating disposed on the main body, which forms a surface of the mold or core that comes into contact with a metal melt in the casting operation, wherein the coating comprises:
(a) particles of one or more refractories
(b) one or more compounds selected from the group consisting of
   β-dicarbonyl compounds
   di- and trihydric phenols
   phenol-formaldehyde novolaks and resorcinol-formaldehyde novolaks
   amino acids
   primary and secondary aminosilanes
   melamine, benzoguanamine, urea and derivatives thereof
   hydrazine and carbonohydrazide and derivatives thereof
   primary and secondary amines
   tree resins, tannins and lignins
and/or reaction products thereof with formaldehyde,
wherein the total mass of free compounds (b) and compounds bound in reaction products with formaldehyde in the coating is 0.1% by weight to 10% by weight, preferably 0.1% by weight to 9% by weight, further preferably 0.1% by weight to 8% by weight, further preferably 0.1% by weight to 7% by weight, further preferably 0.1% by weight to 6% by weight, especially preferably 0.1% by weight to 5% by weight, based on the total mass of the particles (a) of the refractories.

A mold or core of the invention comprises a main body and a coating arranged on said main body that includes the nonvolatile constituents of the composition for use in accordance with the invention in the first aspect of the invention. With regard to the selection of the refractories (a) and compounds (b) as defined above, the same applies as set out above in respect of the first aspect of the invention. Preference is given to molds and cores having a coating as defined above, wherein the refractories (a) and the compounds (b) are selected from the constituents (a) and (b) identified above as being preferred for the first aspect of the invention.

This coating forms a surface of the mold or core that comes into contact with a metal melt in the casting operation. The coating preferably has a thickness in the range from 0.05 mm to 0.6 mm, more preferably 0.05 to 0.4 mm.

Preferably, the coating does not just form the surface of the mold or core that comes into contact with a metal melt in the casting operation, but additionally extends over further regions of the mold or core. The coating preferably extends over 50% or more, further preferably over 70% or more, more preferably over 80% or more, especially preferably over 90% or more, in particular over 95% or more, of the surface of the mold or core. Most preferably, the coating extends over the entire surface of the mold or core.

The main body of the mold or core of the invention emits formaldehyde when heated. At least a noticeable proportion of the formaldehyde emitted by the main body is bound by the compounds (b) present in the coating to form nonvolatile reaction products. Therefore, the coating contains the compounds (b) (especially prior to drying) and/or reaction products thereof with formaldehyde (that form during the drying).

The main body of the mold or core is typically formed from a molding material mixture that has been bound with a binder that emits formaldehyde when heated. The binder is present in cured form in the main body of the mold or core. With regard to the selection of the binders, the same applies as set out above in respect of the first aspect of the invention. Preference is given to binders that are selected from the above binders identified as preferred in respect of the first aspect of the invention. The binder is more preferably selected from the group consisting of
polyurethanes formed by polyaddition of a phenol-formaldehyde resin with polyisocyanate
phenol-formaldehyde resins and
furan-formaldehyde resins.

A fourth aspect of the present invention relates to a process for producing a mold or core of the invention for metal casting. The process comprises the steps of
producing or providing the main body
producing or providing a ready-to-use refractory coating composition as defined above
applying the ready-to-use refractory coating composition to the main body and then drying, such that a coating is produced on the main body, wherein the coating forms a surface of the mold or core that comes into contact with a metal melt in the casting operation.

In the process of the invention, a coating containing the nonvolatile constituents of the composition for use in accordance with the invention in the first aspect of the invention is produced on the main body of the mold or core. This coating forms a surface of the mold or core that comes into contact with a metal melt in the casting operation.

Preferably, the coating does not just form the surface of the mold or core that comes into contact with a metal melt in the casting operation, but additionally extends over further regions of the mold or core. The coating preferably extends over 50% or more, further preferably over 70% or more, more preferably over 80% or more, especially preferably over 90% or more, in particular over 95% or more, of the surface of the mold or core. Most preferably, the coating extends over the entire surface of the mold or core.

The production of the main body of the mold or core typically comprises the following steps:
producing or providing a molding material mixture comprising one or more mold base materials and a binder that emits formaldehyde when heated,
shaping the molding material mixture
curing the binder in the shaped molding material mixture to form the main body of the mold or core.

Corresponding molding material mixtures, shaping methods and curing methods are known to the person skilled in the art.

The binder of the molding material mixture is preferably selected from the group consisting of
two-component systems comprising a phenol-formaldehyde resin and a polyisocyanate to form a polyurethane
formaldehyde condensation resins, preferably selected from the group consisting of phenol-formaldehyde resins, furan-formaldehyde resins, urea-formaldehyde resins, melamine-formaldehyde resins.

The binder is more preferably selected from the group consisting of
polyurethanes formed by polyaddition of a phenol-formaldehyde resin with polyisocyanate
phenol-formaldehyde resins and
furan-formaldehyde resins.

Preference is given to a process of the invention in which the main body of the core or mold is produced by the cold box process. The cold box process is known to the person skilled in the art. In this process, a two-component system comprising a phenol-formaldehyde resin and a polyisocyanate as binder is used. The components of the binder are only contacted with one another in the course of production of the molding material mixture and form a polyurethane in the shaped molding material mixture. The binder in the shaped molding material mixture is cured by contacting the shaped molding material mixture with a gaseous tertiary amine or a mixture of two or more gaseous tertiary amines.

The ready-to-use refractory coating composition used in the process of the invention is preferably selected from the ready-to-use refractory coating compositions containing the constituents (a)-(c) that are preferred in the first aspect of the invention and optionally the constituents (d)-(h) that are preferred in the first aspect of the invention.

The ready-to-use refractory coating composition is applied to the main body typically by a process selected from the group consisting of spraying, dipping, flow coating and painting, preferably dipping, since this process is particularly suitable for forming a coating that extends over the entire surface of the mold or core or at least a large portion of the entire surface of the mold or core.

The refractory coating composition applied is dried at temperatures of 40° C. or more, preferably at a temperature in the range from 50° C. to 200° C., preferably from 100° C. to 180° C.

The main body of the mold or core emits formaldehyde when drying. At least a noticeable proportion of the formaldehyde emitted by the main body is bound by the compounds (b) present in the coating to form nonvolatile reaction products, such that there is a noticeable reduction in the amount of formaldehyde released to the environment in the course of drying of the mold or core.

A fifth aspect of the invention relates to the use of a compound (b) selected from the group consisting of
β-dicarbonyl compounds
di- and trihydric phenols
phenol-formaldehyde novolaks and resorcinol-formaldehyde novolaks
amino acids
primary and secondary aminosilanes
melamine, benzoguanamine, urea and derivatives thereof
hydrazine and carbonohydrazide and derivatives thereof
primary and secondary amines
tree resins, tannins and lignins

as formaldehyde scavenger in a coating on a main body of a mold or core for metal casting that emits formaldehyde when heated, wherein the coating forms a surface of the mold or core that comes into contact with a metal melt in the casting operation, or in a composition for production of such a coating (ready-to-use refractory coating composition as described above in the context of the first aspect of the invention) or for production of such a composition.

Preferably, the coating does not just form the surface of the mold or core that comes into contact with a metal melt in the casting operation, but additionally extends over further regions of the mold or core. The coating preferably extends over 50% or more, further preferably over 70% or more, more preferably over 80% or more, especially preferably over 90% or more, in particular over 95% or more, of the surface of the mold or core. Most preferably, the coating extends over the entire surface of the mold or core.

A formaldehyde scavenger is understood to mean a chemical compound capable of reacting with formaldehyde to give a nonvolatile reaction product, hence reducing the emission of formaldehyde to the environment.

With regard to the selection of the compounds (b) as defined above, the same applies as set out above in respect of the first aspect of the invention. Preference is given to compounds (b) that are selected from the above compounds (b) identified as preferred in respect of the first aspect of the invention.

In the case of use of compounds (b) in the fifth aspect of the invention, it is preferable that the coating or composition for production of such a coating further comprises
(i) one or more refractories selected from the group consisting of quartz, alumina, zirconia, aluminum silicates, nonswellable layered silicates, zirconium silicates, olivine, talc, mica, graphite, coke, feldspar, diatomite, kaolins, calcined kaolins, metakaolinite, iron oxide and bauxite
(ii) optionally one or more refractories selected from the group of the swellable layered silicates and the zeolites.

With regard to the selection of the refractories (i) and (ii), the same applies as set out above in respect of the first aspect of the invention.

A sixth aspect of the invention relates to a kit for production of a mold or core for metal casting according to the third aspect of the invention as defined above. A kit of the invention comprises
(A) a composition as described above for the first aspect of the invention, where the composition is preferably a solid mixture as described above in the context of the first aspect of the invention or a concentrate as described above in the context of the first aspect of the invention,
(B) a binder that emits formaldehyde when heated,

wherein constituents (A) and (B) are separated from one another in the kit.

Within the kit of the invention, there is no possibility of contact of constituents of component (A) with constituents of component (B), for example in that component (A) on the one hand and component (B) on the other hand are each provided in a separate container, or in that component (A) on the one hand and component (B) on the other hand are each provided in a separate chamber of a container.

In the kit of the invention, the composition (A) is preferably selected from the solid mixtures and concentrates that contain the constituents (a) and (b) and optionally (c)-(h) that are preferred in the first aspect of the invention.

In the kit of the invention, the binder (B) is preferably selected from the group consisting of
two-component systems comprising a phenol-formaldehyde resin and a polyisocyanate to form a polyurethane
formaldehyde condensation resins, preferably selected from the group consisting of phenol-formaldehyde resins, furan-formaldehyde resins, urea-formaldehyde resins, melamine-formaldehyde resins.

The binder is more preferably selected from the group consisting of
polyurethanes formed by polyaddition of a phenol-formaldehyde resin with polyisocyanate
phenol-formaldehyde resins and
furan-formaldehyde resins.

The invention is elucidated hereinafter by working examples.

### WORKING EXAMPLES

A molding material mixture comprising H32 sand as mold base material and a two-component binder system customary for core production, comprising a phenol-formaldehyde resin and a polyisocyanate for formation of a polyurethane, was used in the customary manner, by means of a core shooting machine, to shape main bodies for brake disk cores, and these were cured in the customary manner by sparging with tertiary amine (cold box process). Subsequently, a coating is produced on the main core bodies thus produced by applying an inventive composition (inventive refractory coating composition) or a comparative composition (comparative refractory coating composition) that does not contain any of the compounds (b) for use in accordance with the invention. This coating forms the surface of the core that comes into contact with the metal melt in the casting operation. Subsequently, the cores were dried in a drying cabinet (Memmert UFP 700). During the drying, at particular times, samples were taken from the oven air by means of a probe and the formaldehyde content therein was determined by an in-house method (see below for details). For comparison, cores produced in the same way without coating (comparative cores with no refractory coating) were dried in the drying cabinet, and the amount of formaldehyde emitted was measured in the same way.

In a first test series, the effect of drying temperature on the emissions of formaldehyde from comparative cores without refractory coating was examined. The molding material mixture used to produce the cores for this test series contained 0.8% by weight of phenol-formaldehyde resin and 0.8% by weight of polyisocyanate.

During the drying, at particular times, samples were taken from the oven air and the formaldehyde content therein was determined. For this purpose, over the period from commencement of drying to the first measurement time (1 min) and from one measurement time to the next measurement time in each case (drying time 5, 10, 15, 20, 25 and 30 min), by means of a pump Xact 5000 (Dräger), 1.5 l of air was drawn by means of a probe from the oven into a fast detector tube (Drager) for formaldehyde (0.2 to 5 ppm), and the formaldehyde concentration was ascertained.

The The formaldehyde content (in ppm) ascertained at particular times during the drying is reported in the following table:

| | Formaldehyde content [ppm] after x [min] | | | | | | |
|---|---|---|---|---|---|---|---|
| Oven temperature | 1 | 5 | 10 | 15 | 20 | 25 | 30 |
| [° C.] | min | min | min | min | min | min | min |
| 180° C. | 1.5 | 2.5 | 3.0 | 5.0 | 5.0 | 4.0 | 3.0 |
| 150° C. | 0.0 | 1.0 | 1.0 | 1.0 | 1.0 | 1.5 | 1.5 |
| 100° C. | 0.0 | 0.0 | 0.5 | 0.5 | 0.5 | 0.5 | 0.5 |

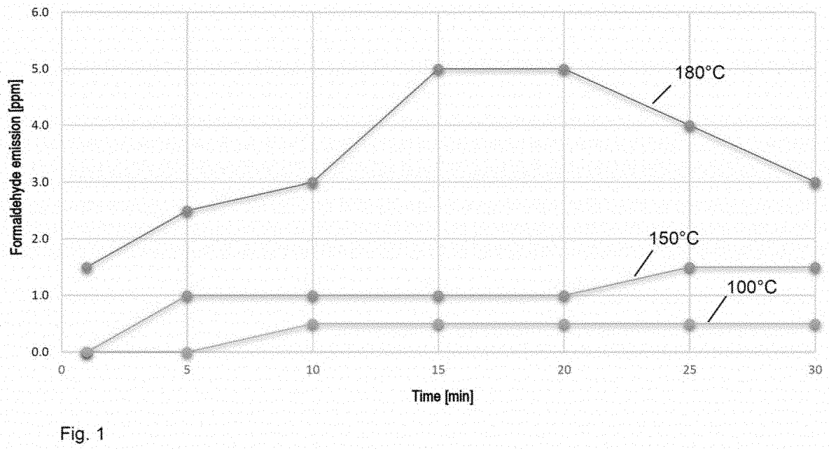

This test series shows that the amount of formaldehyde emitted rises with increasing drying temperature (FIG. 1).

In a second test series, the influence of the composition of the refractory coating (core El with inventive refractory coating composition and core V2 with comparative refractory coating composition) on formaldehyde emissions during drying (30 minutes at 180° C.) was examined. The molding material mixture used to produce the cores for this test series contained 0.8% by weight of phenol-formaldehyde resin and 0.8% by weight of polyisocyanate, based in each case on the mass of the mold base material (H32 sand). The inventive refractory coating composition contained resorcinol as compound (b). For comparison, a comparative core V1 without refractory coating was dried under the same conditions.

The comparative refractory coating composition is as follows:

| | Proportion |
|---|---|
| Constituent | [% by wt.] |
| Refractories (i) | 30.8 in total |
| (aluminum silicates (nonswellable), graphite and iron | |
| oxide) | |
| Refractories (ii) | 3.7 |
| (swellable smectite-containing layered silicates) | |
| Carrier liquid (c) | 64 |
| Wetting agents (d), binders (f), suspension aids (g) | 1.5 in total |
| and biocides (h) | |

The inventive refractory coating composition was produced by adding 3 parts by weight of resorcinol to 100 parts by weight of the comparative refractory coating.

The formaldehyde content (in ppm) ascertained as described above at particular times during the drying is reported in the following table:

| | Formaldehyde content [ppm] after x [min] | | | | | | |
|---|---|---|---|---|---|---|---|
| Test | 1 min | 5 min | 10 min | 15 min | 20 min | 25 min | 30 min |
| V1 | 2.5 | 5.0 | 6.0 | 5.0 | 4.0 | 4.0 | 4.0 |
| V2 | 0.5 | 1.5 | 3.0 | 3.0 | 3.0 | 3.0 | 2.0 |
| E1 | 0.5 | 1.0 | 1.0 | 0.5 | 0.5 | 0.5 | 0.2 |

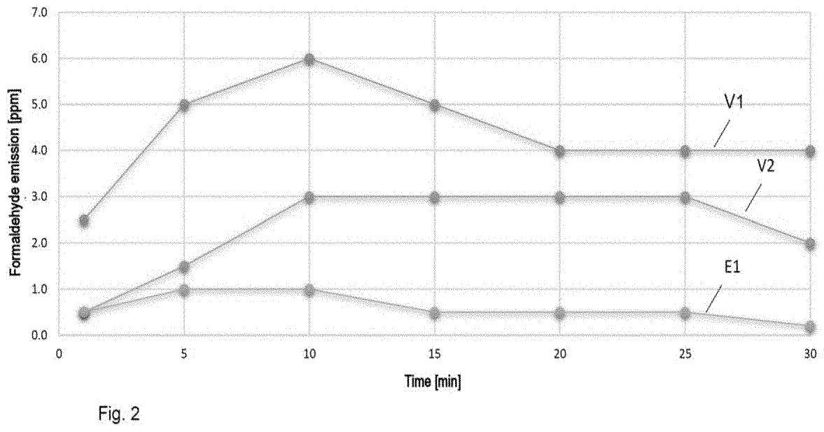

On drying of the comparative core V2 with the coating formed from the noninventive refractory coating, the amount of formaldehyde emitted is already lower than on drying of the comparative core V1 without refractory coating. On drying of the inventive core El (with the coating formed from the inventive refractory coating composition), however, the amount of formaldehyde emitted is much lower again (FIG. 2).

In a third test series, the influence of the amount of resorcinol as compound (b) for use in accordance with the invention on formaldehyde emissions during drying (30 minutes at 180° C.) minutes was examined. The molding material mixture used to produce the cores for this test series contained 1.0% by weight of phenol-formaldehyde resin and 1.0% by weight of polyisocyanate, based in each case on the mass of the mold base material (H32 sand). The cores E2 and E3 each have refractory coatings with different proportions of resorcinol. By way of comparison, a comparative core V3 having no refractory coating and a comparative core V4 with a coating formed from a noninventive refractory coating were dried under the same conditions.

The comparative refractory coating composition is as specified above. The inventive refractory coating compositions were produced by adding 0.8 part by weight of resorcinol (core E2) or 3 parts by weight of resorcinol (core E3) to 100 parts by weight in each case of the comparative refractory coatings.

The formaldehyde content (in ppm) ascertained as described above at particular times during the drying is reported in the following table:

| | Formaldehyde content [ppm] after x [min] | | | | | | |
|---|---|---|---|---|---|---|---|
| Test | 1 min | 5 min | 10 min | 15 min | 20 min | 25 min | 30 min |
| V3 | 1.0 | 5.0 | 5.0 | 5.0 | 7.0 | 7.0 | 7.0 |
| V4 | 0.5 | 2.5 | 3.0 | 3.0 | 3.0 | 3.0 | 2.0 |
| E2 | 0 | 0.0 | 0.2 | 0.5 | 1.0 | 1.5 | 1.0 |
| E3 | 0 | 0.0 | 0.0 | 0.2 | 0.5 | 0.5 | 0.5 |

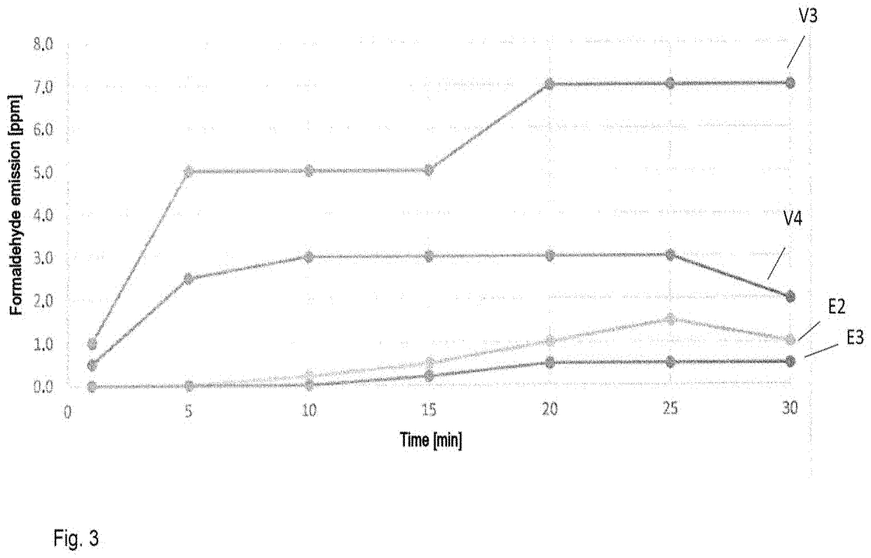

On drying of the comparative core V4 with the coating formed from the noninventive refractory coating, the amount of formaldehyde emitted is already lower than on drying of the comparative core V3 without refractory coating. On drying of the inventive cores E2 and E3, the amount of formaldehyde emitted is much lower, and falls with increasing resorcinol content of the inventive refractory coating composition (FIG. 3).

In a fourth test series, the influence of the composition of the refractory coating (core E4; comparative refractory coating composition, cores E5-E7; various inventive refractory coating compositions) on formaldehyde emissions during drying at 200° C. was monitored over the course of 35 minutes. The molding material mixture used to produce the cores for this test series contained 1% by weight of phenol-formaldehyde resin and 1% by weight of polyisocyanate, based in each case on the mass of the mold base material (H32 sand). For comparison, a comparative core without refractory coating was dried under the same conditions.

The comparative refractory coating composition is as specified above. The inventive refractory coating compositions were produced by adding 0.9 part by weight of lignin (core E5) or 0.9 part by weight of melamine (core E6) or 3 parts by weight of resorcinol (core E7) to 100 parts by weight in each case of the comparative refractory coatings.

The formaldehyde content (in mg/cm³) ascertained at particular times during the drying is reported in the following table:

| | Formaldehyde emission in [mg/m³] | | | | |
|---|---|---|---|---|---|
| Time [min] | V | E4 | E5 | E6 | E7 |
| 5 | 3.06 | 0.94 | 0.31 | 0.36 | 0.33 |
| 10 | 5.42 | 1.10 | 0.10 | 0.59 | 0.63 |
| 15 | 5.60 | 1.25 | 0.09 | 0.66 | 0.74 |
| 20 | 4.81 | 1.48 | 0.07 | 0.98 | 0.86 |
| 25 | 4.66 | 1.65 | 0.04 | 1.21 | 0.96 |
| 30 | 4.77 | 2.90 | 0.08 | 1.50 | 1.13 |
| 35 | 4.54 | 1.96 | 0.08 | 1.70 | 1.25 |

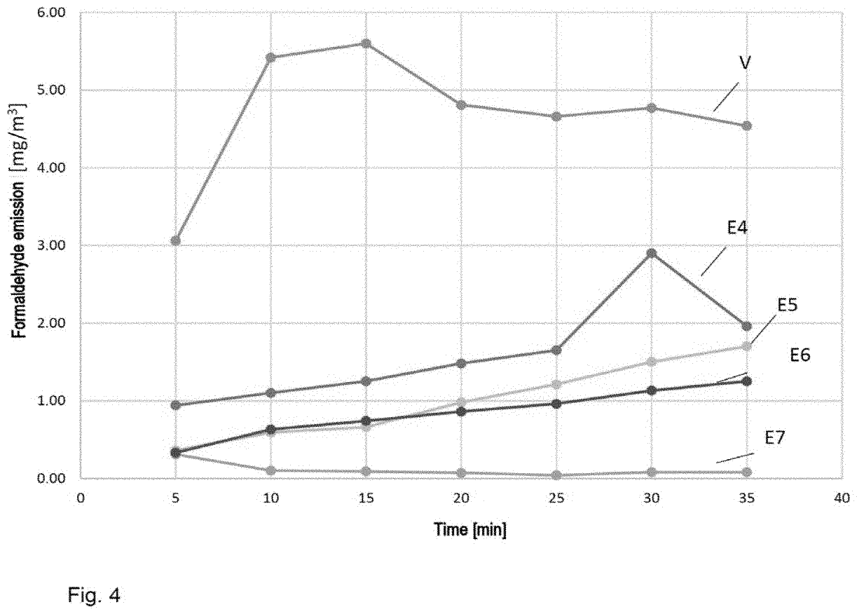

On drying of all inventive cores E4-E7, the amount of formaldehyde emitted is much lower than in the case of the comparative core (FIG. 4).

Similar results were obtained with addition of glycine as compound (b).

In a further test series, the influence of glycine as formaldehyde scavenger on formaldehyde emissions during drying (30 minutes at 180° C.) was examined. For this purpose, in a customary manner, a molding material mixture containing 1% by weight of phenol-formaldehyde resin and 1% by weight of polyisocyanate, based in each case on the mass of the mold base material (H32 sand), was used to produce test specimens (cores for brake disk production) with a core shooting machine, which were cured in the customary manner by sparging with a tertiary amine (cold box process). These test specimens were provided with a refractory coating by dipping (test specimens E8 with inventive refractory coating composition or test specimens V5 with comparative refractory coating composition). The comparative refractory coating composition is as specified above. An inventive refractory coating composition was produced by adding 1 part by weight of glycine to 100 parts by weight of the comparative refractory coatings.

The test specimens provided with the refractory coating were introduced into a preheated drying oven from Elpo (internal temperature 170° C.). The air output volume removed from the drying chamber of the oven during the drying time of 10 minutes is 267 m³. The measurement of the formaldehyde concentration in the oven air began one minute after the test specimen had been introduced into the oven and the oven door had been closed. For sampling, a bar probe was introduced into the offgas tube of the drying oven. With the aid of a Dräger Xact 5000 pump, during the drying time of 10 minutes, the air was drawn out of the drying chamber at a volume flow rate of 1.5 l/min, and the sample volume drawn was guided through LpDNPH cartridges (LpDNPH Cartridge S10 from Supelco). Analysis was effected by means of HPLC analogously to DIN 16000-3.

| | mg formaldehyde/m³ output air | |
|---|---|---|
| Test | in 10 minutes of drying time | |
| V5 | 0.82 | 100% |
| E8 | 0.51 | 62% |

On drying of the inventive test specimen E8 (with the coating formed from the inventive refractory coating composition), the concentration of formaldehyde in the output air from the oven is reduced by more than one third compared to the comparative test specimen V5 with the coating formed from the noninventive refractory coating.

We claim:

1. A method of production of a coating on a main body of a mold or core for metal casting, comprising:
applying on the main body of the mold or core for metal casting
a composition comprising
(a) particles of one or more refractories
(b) one or more compounds selected from the group consisting of
β-dicarbonyl compounds
di- and trihydric phenols
phenol-formaldehyde novolaks and resorcinol-formaldehyde novolaks
amino acids
primary and secondary aminosilanes
melamine, benzoguanamine, urea and derivatives thereof
hydrazine and carbonohydrazide and derivatives thereof
primary and secondary amines
tree resins, tannins and lignins
where the total mass of compounds (b) is 0.1% by weight to 10% by weight, based on the total mass of the particles (a) of the refractories,
(c) optionally a carrier liquid selected from the group consisting of water, alkanols and mixtures thereof,
wherein the composition emits formaldehyde when heated, and
wherein the coating forms a surface of the mold or core that comes into contact with a metal melt in the casting operation.

2. The method as claimed in claim 1, wherein
the compounds (b) are selected from the group consisting of dialkyl esters of malonic acid, resorcinol, pyrogallol, phloroglucinol, glycine, urea, melamine, carbonohydrazide, and tannins and lignins that are soluble in the carrier liquid (c)
and/or
the refractories (a) comprise:
(i) one or more refractories selected from the group consisting of quartz, alumina, zirconia, aluminum silicates, nonswellable layered silicates, zirconium silicates, olivine, talc, mica, graphite, coke, feldspar, diatomite, kaolins, calcined kaolins, metakaolinite, iron oxide and bauxite
and
(ii) one or more refractories selected from the group of the swellable layered silicates and the zeolites
and/or
the carrier liquid (c) is selected from the group consisting of water, methanol, ethanol and isopropanol
and/or
the main body of the mold or core has been formed from a molding material mixture that has been bound with a binder that emits formaldehyde when heated.

3. The method as claimed in claim 1, wherein the binder is selected from the group consisting of:
polyurethanes formed by polyaddition of a phenol-formaldehyde resin with a polyisocyanate
formaldehyde condensation resins selected from the group consisting of phenol-formaldehyde resins, furan-formaldehyde resins, urea-formaldehyde resins and melamine-formaldehyde resins.

4. The method as claimed in claim 1, wherein the composition comprises one or more further constituents selected from the group consisting of
(d) wetting agents,
(e) rheology additives,
(f) binders,
(g) suspension aids,
(h) biocides.

5. The method as claimed in claim 1, wherein the composition
does not contain any carrier liquid (c),
or
contains a carrier liquid (c), wherein the total mass of the carrier liquid (c) is 40% by weight to 65% by weight based in each case on the total mass of the composition.

6. The method as claimed in claim 1, wherein the composition contains a carrier liquid (c), wherein the total mass of the carrier liquid (c) is 60% by weight to 80% by weight, based on the total mass of the composition.

7. A process for producing a composition as defined in claim 6, comprising the steps of
producing or providing a composition comprising:
(a) particles of one or more refractories
(b) one or more compounds selected from the group consisting of
β-dicarbonyl compounds,
di- and trihydric phenols,
phenol-formaldehyde novolaks and resorcinol-formaldehyde novolaks,
amino acids,
primary and secondary aminosilanes,
melamine, benzoguanamine, urea and derivatives thereof,
hydrazine and carbonohydrazide and derivatives thereof,
primary and secondary amines,
tree resins, tannins and lignins,
where the total mass of compounds (b) is 0.1% by weight to 10% by weight, based on the total mass of the particles (a) of the refractories,
(c) either no carrier liquid or a carrier liquid selected from the group consisting of water, alkanols and mixtures thereof, wherein a total mass of the carrier liquid is 40% by weight to 65% by weight based on a total mass of the composition; and
adding a carrier liquid selected from the group consisting of water, alkanols and mixtures thereof, wherein the amount of carrier liquid (c) added is such as to result in a composition in which the total amount of the carrier liquid (c) is 60% by weight to 80% by weight, based on the total mass of the resulting composition.

8. A composition for producing a coating on a main body of a mold or core for metal casting that emits formaldehyde when heated, wherein the coating forms a surface of the mold or core that comes into contact with a metal melt in the casting operation, wherein the composition comprises
(a) particles of one or more refractories
(b) one or more compounds selected from the group consisting of
β-dicarbonyl compounds
di- and trihydric phenols
phenol-formaldehyde novolaks and resorcinol-formaldehyde novolaks
amino acids
primary and secondary aminosilanes
melamine, benzoguanamine, urea and derivatives thereof
hydrazine and carbonohydrazide and derivatives thereof
primary and secondary amines
tree resins, tannins and lignins
where the total mass of compounds (b) is 0.1% by weight to 10% by weight, based on the total mass of the particles (a) of the refractories,
(c) a carrier liquid selected from the group consisting of water, alkanols and mixtures thereof, where the total mass of the carrier liquid (c) is 40% by weight to 80% by weight, based on the total mass of the composition.

9. The composition as claimed in claim 8, wherein
the compounds (b) are selected from the group consisting of dialkyl esters of malonic acid, resorcinol, pyrogallol, phloroglucinol, glycine, melamine, urea, carbonohydrazide, and tannins and lignins that are soluble in the carrier liquid (c)
and/or
the refractories (a) comprise:
(i) one or more refractories selected from the group consisting of quartz, alumina, zirconia, aluminum silicates, nonswellable layered silicates, zirconium silicates, olivine, talc, mica, graphite, coke, feldspar, diatomite, kaolins, calcined kaolins, metakaolinite, iron oxide and bauxite
(ii) one or more refractories selected from the group of the swellable layered silicates and the zeolites
and/or
the carrier liquid (c) is selected from the group consisting of water, methanol, ethanol and isopropanol and mixtures thereof.

10. The composition as claimed in claim 8, further comprising one or more constituents selected from the group consisting of
(d) wetting agents
(e) rheology additives
(f) binders
(g) suspension aids
(h) biocides.

11. A mold or core for metal casting, comprising
a main body that emits formaldehyde when heated,
and a coating disposed on the main body, which forms a surface of the mold or core that comes into contact with a metal melt in the casting operation, wherein the coating comprises:
(a) particles of one or more refractories
(b) one or more compounds selected from the group consisting of
β-dicarbonyl compounds
di- and trihydric phenols
phenol-formaldehyde novolaks and resorcinol-formaldehyde novolaks
amino acids
primary and secondary aminosilanes
melamine, benzoguanamine, urea and derivatives thereof
hydrazine and carbonohydrazide and derivatives thereof
primary and secondary amines
tree resins, tannins and lignins
and/or reaction products thereof with formaldehyde,
wherein the total mass of the free compounds (b) and of those bound in reaction products with formaldehyde in the coating is 0.1% to 10% by weight, based on the total mass of the particles (a) in the refractories.

12. The mold or core as claimed in claim 11, wherein
the compounds (b) are selected from the group consisting of dialkyl esters of malonic acid, resorcinol, pyrogallol, phloroglucinol, glycine, melamine, urea, carbonohydrazide, tannins and lignins
and/or
the refractories (a) comprise:
(i) one or more refractories selected from the group consisting of quartz, alumina, zirconia, aluminum silicates, nonswellable layered silicates, zirconium silicates, olivine, talc, mica, graphite, coke, feldspar, diatomite, kaolins, calcined kaolins, metakaolinite, iron oxide and bauxite
and
(ii) one or more refractories selected from the group of the swellable layered silicates and the zeolites
and/or
the main body of the mold or core has been formed from a molding material mixture that has been bound with a binder that emits formaldehyde when heated.

13. The mold or core as claimed in claim 11, wherein the binder is selected from the group consisting of:
polyurethanes formed by polyaddition of a phenol-formaldehyde resin with a polyisocyanate
formaldehyde condensation resins selected from the group consisting of phenol-formaldehyde resins, furan-formaldehyde resins, urea-formaldehyde resins and melamine-formaldehyde resins.

14. The mold or core as claimed in claim 11, wherein the coating has a thickness in the range from 0.05 mm to 0.6 mm.

15. A process for producing a mold or core for metal casting as claimed in claim 11, comprising the steps of
producing or providing the main body
producing or providing a composition
applying the composition to the main body and then drying, such that a coating is produced on the main body, wherein the coating forms a surface of the mold or core that comes into contact with a metal melt in the casting operation,
wherein the composition comprises:
(a) particles of one or more refractories
(b) one or more compounds selected from the group consisting of
β-dicarbonyl compounds,
di- and trihydric phenols,
phenol-formaldehyde novolaks and resorcinol-formaldehyde novolaks,
amino acids,
primary and secondary aminosilanes,
melamine, benzoguanamine, urea and derivatives thereof,
hydrazine and carbonohydrazide and derivatives thereof,
primary and secondary amines,
tree resins, tannins and lignins,
where the total mass of compounds (b) is 0.1% by weight to 10% by weight, based on the total mass of the particles (a) of the refractories,
(c) a carrier liquid selected from the group consisting of water, alkanols and mixtures thereof, wherein a total mass of the carrier liquid is 60% by weight to 80% by weight based on a total mass of the composition.

16. The process as claimed in claim 15, wherein the producing of the main body of the mold or core comprises the following steps:
producing or providing a molding material mixture comprising one or more mold base materials and a binder that emits formaldehyde when heated,
shaping the molding material mixture
curing the binder in the shaped molding material mixture to form the main body of the mold or core.

17. The process as claimed in claim 16, wherein the binder is selected from the group consisting of
two-component systems comprising a phenol-formaldehyde resin and a polyisocyanate to form a polyurethane
formaldehyde condensation resins selected from the group consisting of phenol-formaldehyde resins, furan-formaldehyde resins, urea-formaldehyde resins and melamine-formaldehyde resins.

18. The process as claimed in claim 17, wherein
the binder is a two-component system comprising a phenol-formaldehyde resin and a polyisocyanate to form a polyurethane
and the binder in the shaped molding material mixture is cured by contacting the shaped molding material mixture with a gaseous tertiary amine or a mixture of two or more gaseous tertiary amines.

19. The process as claimed in claim 15, wherein the composition is applied to the main body by a process selected from the group consisting of spraying, dipping, flow coating and painting.

20. The process as claimed in claim 15, wherein the drying is effected at a temperature in the range from 50° C. to 200° C.

21-22. (canceled)

23. A kit for producing a mold or core for metal casting as defined in claim 11,
wherein the kit comprises
(A) a composition comprising,
(a) particles of one or more refractories
(b) one or more compounds selected from the group consisting of
β-dicarbonyl compounds
di- and trihydric phenols
phenol-formaldehyde novolaks and resorcinol-formaldehyde novolaks
amino acids
primary and secondary aminosilanes
melamine, benzoguanamine, urea and derivatives thereof
hydrazine and carbonohydrazide and derivatives thereof
primary and secondary amines
tree resins, tannins and lignins
where the total mass of compounds (b) is 0.1% by weight to 10% by weight, based on the total mass of the particles (a) of the refractories,
(c) optionally a carrier liquid selected from the group consisting of water, alkanols and mixtures thereof,
(B) a binder that emits formaldehyde when heated,
wherein constituents (A) and (B) are separated from one another in the kit.

24. The kit as claimed in claim 23, wherein the binder is selected from the group consisting of
two-component systems comprising a phenol-formaldehyde resin and a polyisocyanate to form a polyurethane
formaldehyde condensation resins, preferably selected from the group consisting of phenol-formaldehyde resins, furan-formaldehyde resins, urea-formaldehyde resins and melamine-formaldehyde resins.
